(19) United States
(12) Patent Application Publication
(10) Pub. No.: US 2010/0233986 A1
(43) Pub. Date: Sep. 16, 2010

(54) RECEIVER

(75) Inventors: Takafumi Yamaji, Yokohama-shi (JP); Junya Matsuno, Atsugi-shi (JP); Hiromitsu Aoyama, Yokohama-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/579,742

(22) Filed: Oct. 15, 2009

(30) Foreign Application Priority Data
Mar. 13, 2009 (JP) 2009-062009

(51) Int. Cl. H04B 15/00

(52) U.S. Cl. 455/314

(57) ABSTRACT

A receiver includes a high-frequency filter which extracts, from a radio signal, a high-frequency signal, a first frequency converter which performs frequency conversion on the high-frequency signal using a first local signal, to obtain a first baseband signal, a second frequency converter which performs frequency conversion on the high-frequency signal using a second local signal, to obtain a second baseband signal, the second local signal having a frequency equal to an integral multiple of a frequency of the first local signal, and a subtraction processing unit configured to multiply the second baseband signal by a control coefficient for amplitude adjustment to obtain a product signal, and subtract the product signal from the first baseband signal to obtain a residual signal.

### CROSS-REFERENCE TO RELATED APPLICATIONS

This application is based upon and claims the benefit of priority from prior Japanese Patent Application No. 2009-062009, filed Mar. 13, 2009, the entire contents of which are incorporated herein by reference.

### BACKGROUND OF THE INVENTION

1. Field of the Invention

The present invention relates to a receiver for broadband signals.

2. Description of the Related Art

In wireless receivers, a frequency conversion circuit performs down-convert processing in which a high-frequency radio signal is multiplied by a preset local signal to thereby generate a baseband signal. In general, a pulse wave having a preset fundamental frequency is used as the local signal. Further, the frequency conversion circuit is often formed of a transistor switch that is on/off controlled by the local signal, and the amplitude of the local signal is set to a relatively high value in view of stable operation. The local signal contains, as well as the fundamental frequency component, harmonic components as signal components having frequencies equal to integral multiples of the fundamental frequency. Accordingly, if an interference wave having a frequency, the difference between which and the frequency of a radio signal as a reception target is an integral multiple of the fundamental frequency, is received, the frequency of the interference wave is also converted into the frequency (hereinafter referred to simply as “the baseband frequency”) equal to that of the baseband signal by the down-convert process. If the interference wave is superimposed on the baseband signal, the quality of reception (e.g., the SN ratio) is degraded.

In view of avoiding degradation of the reception quality due to interference waves, it is advantageous to suppress the signal components falling outside a reception target band, using a high frequency filter usually provided before the frequency conversion circuit. However, if the reception target band is a broadband (more specifically, if the upper limit of the reception target band is twice or more the lower limit thereof), it is necessary to employ a plurality of narrowband high-frequency filters or a high-frequency filter having a variable frequency characteristic in order to sufficiently remove interference waves. For instance, in the case of a TV broadcast receiver, the reception target (broadcast wave) band ranges from approx. 100 MHz to approx. 1 GHz, and therefore another broadcast wave may well exist near integral multiples of a desired frequency. If the broadcast wave falls within the passband of the high-frequency filter, it will be multiplied by a harmonic component of the local signal, and hence be superimposed on the baseband signal.

V. Fillatre, at el. “A SiP Tuner with Integrated LC Tracking Filter for both Cable and Terrestrial TV Reception”, 2007 IEEE International Solid-State Circuits Conference, pp. 208-209 (hereinafter referred to simply as “the related art”) describes a TV tuner in which a high-frequency filter of a variable frequency characteristic is provided before a frequency conversion circuit. By virtue of this high-frequency filter, the TV tuner can eliminate, even from a broadband signal, interference waves that have frequencies near integral multiples of a desired frequency. However, the tunable filter (a high-frequency filter whose frequency characteristic is variable) of the TV tuner is hard to mount on a silicon chip. To be more specific, as described in the related art, it is necessary to mount a large number of external components around the chip. The mounting of the components around the chip requires not only the cost of each component itself but also the cost of integrating the components and the chip as a module. Further, when the tunable filter is mounted on the chip, a large mounting area is needed and hence the manufacturing cost of the chip itself is increased.

### BRIEF SUMMARY OF THE INVENTION

According to an aspect of the invention, there is provided a receiver comprising: a high-frequency filter which extracts, from a radio signal, a high-frequency signal; a first frequency converter which performs frequency conversion on the high-frequency signal using a first local signal, to obtain a first baseband signal; a second frequency converter which performs frequency conversion on the high-frequency signal using a second local signal, to obtain a second baseband signal, the second local signal having a frequency equal to an integral multiple of a frequency of the first local signal; and a subtraction processing unit configured to multiply the second baseband signal by a control coefficient for amplitude adjustment to obtain a product signal, and subtract the product signal from the first baseband signal to obtain a residual signal.

According to another aspect of the invention, there is provided a receiver comprising: a high-frequency filter which extracts, from a radio signal, a high-frequency signal; a first frequency converter which performs frequency conversion on the high-frequency signal using a first local signal, to obtain a first baseband signal; a second frequency converter which performs frequency conversion on the high-frequency signal using a second local signal, to obtain a second baseband signal, the second local signal having a frequency equal to an integral multiple of a frequency of the first local signal; a third frequency converter which performs frequency conversion on the high-frequency signal using a third local signal, to obtain a third baseband signal, the third local signal having a frequency that is equal to an integral multiple of the frequency of the first local signal and differs from the frequency of the second local signal; and a subtraction processing unit configured to multiply the second baseband signal by a first control coefficient for amplitude adjustment to obtain a first product signal, multiply the third baseband signal by a second control coefficient for amplitude adjustment to obtain a second product signal, subtract the first product signal and the second product signal from the first baseband signal to obtain a residual signal.

According to another aspect of the invention, there is provided a receiver comprising: a high-frequency filter which extracts, from a radio signal, a high-frequency signal; a first frequency converter which multiplies the high-frequency signal by a polyphase local signal to obtain a polyphase signal, combines signal components of the polyphase signal into a first combination signal, and cancels a signal component of the first combination signal due to a harmonic component of the polyphase local signal, to obtain a first baseband signal; a second frequency converter which multiplies the high-frequency signal by the polyphase local signal to obtain the polyphase signal, combines signal components of the polyphase signal into a second combination signal, and cancels a signal component of the second combination signal due to a fundamental wave component of the polyphase local signal, to obtain a second baseband signal; and a subtraction processing unit configured to multiply the second baseband signal by a control coefficient for amplitude adjustment to obtain a product signal, and subtract the product signal from the first baseband signal to obtain a residual signal.

### BRIEF DESCRIPTION OF THE SEVERAL VIEWS OF THE DRAWING

FIG. 1 is a block diagram illustrating a receiver according to a first embodiment;

FIG. 2 is a block diagram illustrating a receiver according to a second embodiment;

FIG. 3 is a block diagram illustrating the interior of the correlation computation unit shown in FIG. 2;

FIG. 4 is a block diagram illustrating an example of a local signal generation unit for generating a local signal supplied to the frequency conversion unit shown in FIG. 2;

FIG. 5 is a block diagram illustrating another example of the local signal generation unit for generating a local signal supplied to the frequency conversion unit shown in FIG. 2;

FIG. 6 is a block diagram illustrating a receiver according to a third embodiment;

FIG. 7 is a block diagram illustrating a receiver according to a fourth embodiment;

FIG. 8 is a block diagram illustrating a receiver according to a fifth embodiment;

FIG. 9 is a block diagram illustrating an example of the frequency conversion unit shown in FIG. 8; and

FIG. 10 is a block diagram illustrating another example of the frequency conversion unit shown in FIG. 8.

### DETAILED DESCRIPTION OF THE INVENTION

Embodiments of the present invention will be described with reference to the accompanying drawings.

### First Embodiment

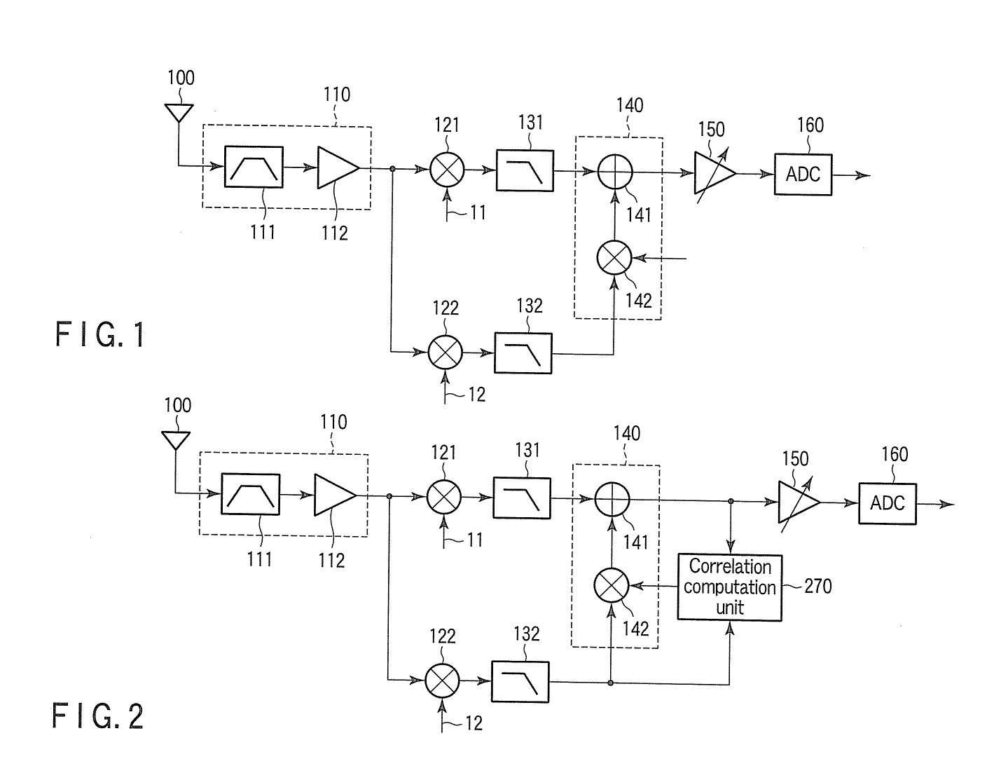

As shown in FIG. 1, a receiver according to a first embodiment comprises an antenna 100, a high-frequency amplifying unit 110, frequency converters 121 and 122, baseband filters 131 and 132, a subtraction processing unit 140, a variable gain amplifier (hereinafter referred to simply as “the VGA”) 150 and an analog-to-digital converter (hereinafter, “the ADC”) 160.

The antenna 100 receives an RF signal and supplies the same to the high-frequency amplifying unit 110.

The high-frequency amplifying unit 110 extracts, from the RF signal received by the antenna 100, a signal component falling within a band as a reception target band for the receiver of FIG. 1, and amplifies the signal component to obtain an amplified signal. The high-frequency amplifying unit 110 supplies the amplified signal to the frequency converters 121 and 122. More specifically, the high-frequency amplifying unit 110 includes a high-frequency filter 111 and a low noise amplifier (LNA) 112.

The high-frequency filter 111 performs filtering for suppressing a signal component that is contained in the RF signal sent from the antenna 100 and falls outside the reception target band for the receiver of FIG. 1. In other words, the high-frequency filter 111 performs filtering for extracting, from the RF signal sent from the antenna 100, a signal component falling within the reception target band. The high-frequency filter 111 supplies the filtered signal to the LAN 112. Assume here that the reception target band is relatively broad, and that more specifically, the upper limit of the band is at least twice or more the lower limit. Namely, the signal sent from the high-frequency filter 111 to the LNA 112 may contain an interference wave near an integral multiple (e.g., double) of a desired frequency. The LNA 112 amplifies the signal received from the high-frequency filter 111 to obtain an amplified signal. The LNA 112 supplies the amplified signal to the frequency converters 121 and 122.

The frequency converter 121 performs frequency conversion in which the amplified signal from the LNA 112 is multiplied by a first local signal 11, thereby obtaining a product signal. The first local signal 11 is used to convert, into the baseband frequency, the frequency of a desired wave contained in the amplified signal from the LNA 112. Namely, the frequency of the first local signal 11 corresponds to the difference between the desired frequency and the baseband frequency. The frequency converter 121 supplies the product signal to the baseband filter 131.

The baseband filter 131 is a so-called low-pass filter (LPF). The baseband filter 131 performs filtering for suppressing a high-frequency component contained in the product signal from the frequency converter 121. In other words, the baseband filter 131 performs filtering for extracting, from the frequency converter 121, a baseband signal as the low-frequency component of the amplified signal. The baseband filter 131 supplies the baseband signal (hereinafter, also referred to as “the first baseband signal”) to a subtraction processing unit 140. It should be noted that the first baseband signal contains a component due to an interference wave (to be more specific, a component corresponding to the result of multiplication of an interference component near an integral multiple of a desired frequency and the harmonic component of the first local signal 11).

The frequency converter 122 performs frequency conversion in which the amplified signal from the LNA 112 is multiplied by a second local signal 12, thereby obtaining a product signal. The second local signal 11 is used to convert, into the baseband frequency, the frequency of a target interference wave contained in the amplified signal from the LNA 112. Namely, the frequency of the second local signal 12 corresponds to the difference between the target interference frequency and the baseband frequency. Assume here that the target interference wave is a signal of a frequency near an arbitrary integral multiple (e.g., 2) of a desired frequency. Accordingly, the frequency of the second local signal 12 corresponds to the above-mentioned integral multiple of the first local signal 11. The frequency converter 122 supplies the product signal to the baseband filter 132.

The baseband filter 132 is an LPF. The baseband filter 132 performs filtering for suppressing a high-frequency component contained in the product signal from the frequency converter 122. In other words, the baseband filter 132 performs filtering for extracting, from the frequency converter 122, a baseband signal as the low-frequency component of the amplified signal. The baseband filter 132 supplies the baseband signal (hereinafter, also referred to as “the second baseband signal”) to the subtraction processing unit 140.

The subtraction processing unit 140 adjusts the amplitude of the second baseband signal, and then subtracts the same from the first baseband signal to obtain a residual signal. The subtraction processing unit 140 supplies the residual signal to the VGA 150. To be more specific, the subtraction processing unit 140 includes an adder 141 and a multiplier 142.

The multiplier 142 multiplies the second baseband signal by a control coefficient to obtain a product signal. Specifically, it is desirable that the control coefficient be obtained by inverting the sign of the ratio of the part of the amplitude component of the first baseband signal, which is based on a target interference wave, to the amplitude of the second baseband signal. The multiplier 142 supplies the product signal to the adder 141.

The adder 141 adds the first baseband signal from the baseband filter 131, to the product signal from the multiplier 142, thereby obtaining the aforementioned residual signal. If the control coefficient is an appropriate value, the component contained in the first baseband signal and based on the target interference wave is canceled out from the residual signal.

The control coefficient may be variable. Alternatively, the control coefficient may be fixed if variations in the conversion gains of the frequency converters 121 and 122 do not greatly depend on their temperatures or the frequencies that the converters process. Further, the control coefficient may be determined manually or automatically. The frequency converters 121 and 122 may be orthogonal demodulators that output orthogonal signals (i.e., I and Q signals). In this case, the control coefficient is a complex number or a real number coefficient matrix of two rows and two columns. The subtraction processing unit 140 performs complex number operation or matrix operation to suppress the phenomenon that an amplitude error or a phase error due to the second baseband signal is contained in the residual signal.

The VGA 150 imparts an appropriate gain to the residual signal sent from the subtraction processing unit 140, thereby amplifying the residual signal to obtain an amplified signal. The VGA 150 supplies the amplified signal to the ADC 160. The ADC 160 performs analog-to-digital conversion on the amplified signal to obtain a digital signal. The ADC 160 supplies the digital signal to a digital processing unit (not shown).

As described above, the receiver of the first embodiment cancels the signal component based on a target interference wave using the subtraction processing unit provided after the frequency converters, although the signal component based on the target interference wave is temporarily superimposed on the baseband signal. Accordingly, in the receiver of the first embodiment, the structure of the high-frequency filters provided before the frequency converters can be simplified, thereby realizing low cost.

### Second Embodiment

As shown in FIG. 2, a receiver according to a second embodiment of the invention comprises a correlation computation unit 270, in addition to the elements incorporated in the receiver of FIG. 1. In FIG. 2, elements similar to those of FIG. 1 are denoted by corresponding reference numbers, and different elements will be mainly described.

The correlation computation unit 270 computes a correlation between the residual signal from the subtraction processing unit 140 and the second baseband signal from the baseband filter 132. The correlation is used as an index that indicates the ratio of the component, which is contained in the residual signal and based on the target interference wave, to the whole residual signal. The correlation computation unit 270 imparts an appropriate gain to the correlation, and supplies the multiplier 142 with the resultant signal as the aforementioned control coefficient. The correlation is controlled to approach 0 by the feedback operation of the correlation computation unit 270 and the subtraction processing unit 140.

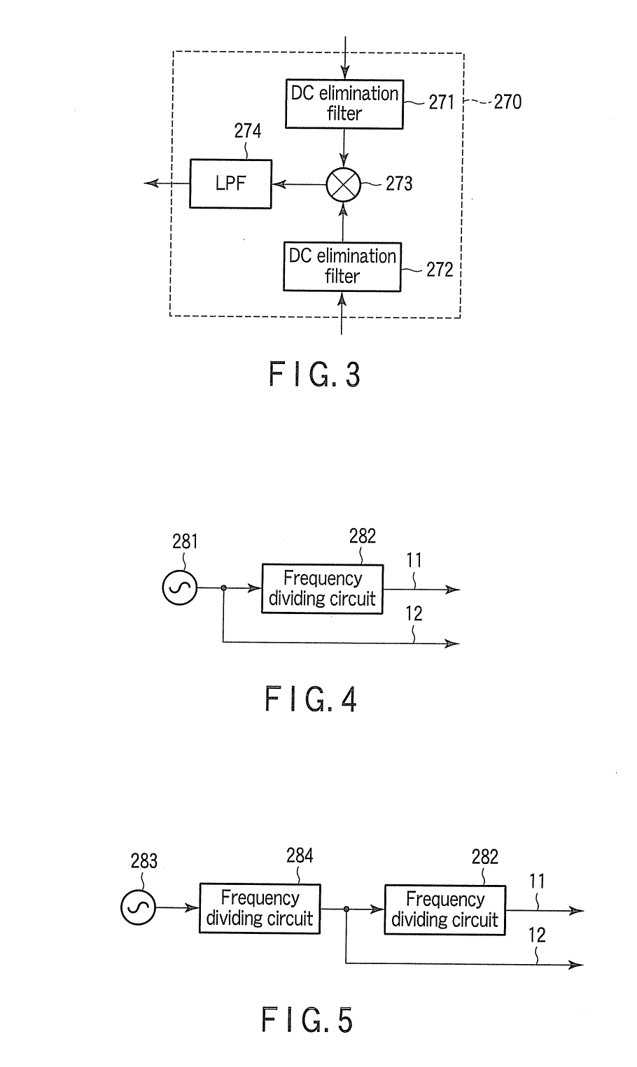

The correlation computation unit 270 can be formed of, for example, DC elimination filters 271 and 272, a multiplier 273 and an LPF 274, as shown in FIG. 3.

The DC elimination filter 271 is, for example, a so-called high-pass filter (HPF) or a band-pass filter (BPF). The DC elimination filter 271 performs filtering to suppress the DC component of the residual signal and obtain a first filter signal.

The DC elimination filter 272 is, for example, an HPF or a BPF. The DC elimination filter 272 performs filtering to suppress the DC component of the second baseband signal and obtain a second filter signal.

The technical significance of the provision of the DC elimination filters 271 and 272 will be described. In general, the output signal of an analog circuit (in particular, the frequency converter 121 or 122) contains a certain amount of a DC component (DC offset) regardless of whether there is an input signal. The level of the DC component depends upon, variations in the elements of the analog circuit. Since it is not preferable that variations in DC component due to the structure of the analog circuit influences the correlation computation of the correlation computation unit 270, the DC elimination filters 271 and 272 used to eliminate the DC component are incorporated in the correlation computation unit 270.

Further, in view of suppressing the DC offset, it is also advantageous to construct the local signal generation unit for generating the first and second local signals 11 and 12 as shown in FIG. 4 or 5. In receivers of a so-called direct conversion scheme, the frequency of an oscillation signal may be often set to a value corresponding to an integral multiple of the frequency of a local signal supplied to a frequency converter, in order to avoid the problem that the oscillation signal generated by an oscillator is directly input to a high-frequency amplifier, and is converted into a DC offset by the frequency converter. In this case, the local signal is generated by dividing the frequency of the oscillation signal using a frequency dividing circuit. Since in this structure, the frequency difference between a desired wave and the oscillation signal is increased, the above-mentioned problem that the oscillation signal generated by the oscillator is directly input to the high-frequency amplifier, and is converted into the DC offset by the frequency converter can be avoided.

In the structure shown in FIG. 4, the oscillation signal generated by an oscillator 281 is directly used as the second local signal 12, and is subjected to a frequency dividing process performed by a frequency dividing circuit 282, whereby the first local signal 11 is generated. The structure of FIG. 4 needs to increase the load driving performance of the output section of the oscillator 281, but is substantially the same as the fundamental structure of the local signal generating unit employed in receivers of the conventional direct conversion scheme.

In the structure shown in FIG. 5, the oscillation signal generated by an oscillator 283 is subjected to a frequency dividing process performed by a frequency dividing circuit 284, and the resultant signal is used as the second local signal 12. The resultant signal is further subjected to a frequency dividing process performed by the frequency dividing circuit 281, whereby the first local signal 11 is generated. The structure of FIG. 5 can better suppress the DC offset to be converted by the frequency converter 122, than the structure of FIG. 4. In general, the sensitivity required for the frequency converter 122 is lower than that required for the frequency converter 121, and hence the structure of FIG. 4 may sufficiently cancel the interference wave. However, to realize more accurate interference wave canceling, the structure of FIG. 5 should be employed.

The multiplier 273 multiplies the first filter signal from the DC eliminating filter 271 by the second filter signal from the DC eliminating filter 272, thereby obtaining a product signal. The multiplier 273 supplies the product signal to the LPF 274.

The LPF 274 performs a filtering process of extracting a low-band component from the product signal sent from the multiplier 273 (namely, smoothes the product signal), thereby obtaining the above-mentioned control coefficient. The LPF 274 supplies the control coefficient to the multiplier 142. Theoretically, the computation of the correlation between the residual signal and the second baseband signal is equivalent to infinite integration. Practically, however, the correlation is approximately computed by an integration process using a so-called integration circuit, or by a filtering process using an LPF.

Further, if the frequency converters 121 and 122 are orthogonal demodulators, a pair of correlation computation units 270 may be employed. In this case, the correlation computation units 270 compute the correlation between I signals and the correlation between Q signals, thereby generating control coefficients corresponding to the real part and the imaginary part of a complex number representing the computed correlations. Yet alternatively, four correlation computation units 270 may be employed. In this case, the respective correlation computation units 270 compute the correlation between the I signal of the residual signal and the I signal of the second baseband signal, that between the I signal of the residual signal and the Q signal of the second baseband signal, that between the Q signal of the residual signal and the I signal of the second baseband signal, that between the Q signal of the residual signal and the Q signal of the second baseband signal, thereby generating control coefficients.

As described above, the receiver of the second embodiment comprises the correlation computation unit, in addition to the elements incorporated in the receiver of FIG. 1, and performs feedback control of the control coefficient(s). Therefore, the receiver of the second embodiment can enhance the interference wave canceling accuracy of the receiver of the first embodiment.

### Third Embodiment

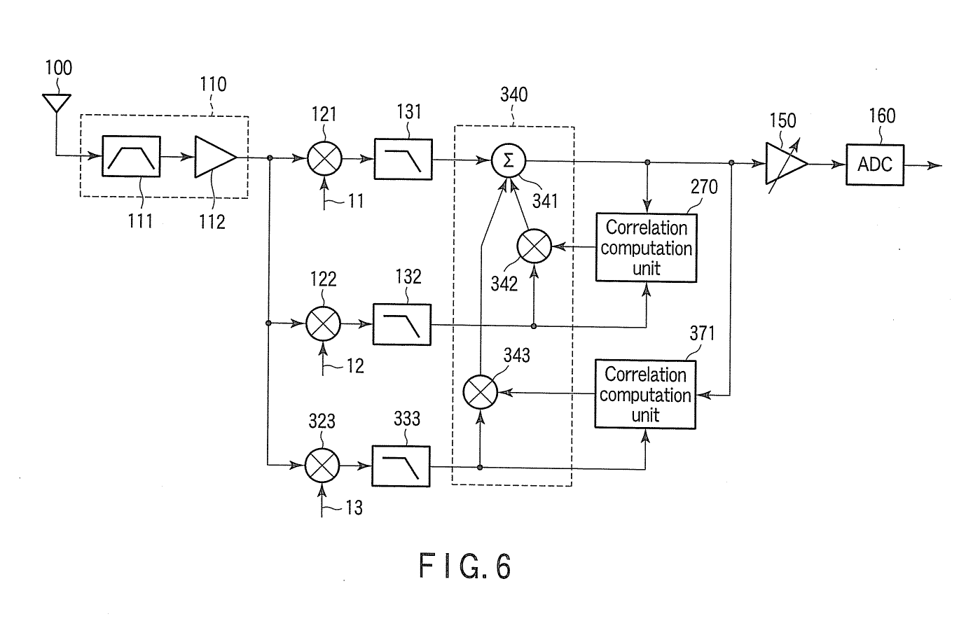

As shown in FIG. 6, a receiver according to a third embodiment of the invention is obtained by modifying the receiver shown in FIG. 2 such that the subtraction processing unit 140 is replaced with a subtraction processing unit 340, and a frequency converter 323, a baseband filter 333 and a correlation computation unit 371 are additionally provided. In FIG. 6 and the description corresponding thereto, elements similar to those of FIG. 2 are denoted by corresponding reference numbers, and the different elements will be mainly described.

The frequency converter 323 performs frequency conversion in which the amplified signal from the LNA 112 is multiplied by a third local signal 13, thereby obtaining a product signal. The third local signal 13 is used to convert, into a baseband frequency, the frequency of a second target interference wave contained in the amplified signal from the LNA 112. Namely, the frequency of the third local signal 13 corresponds to the difference between the frequency of the second target interference wave and the baseband frequency. Assume here that the second target interference wave has a frequency near an integral multiple (e.g., triple) of a desired frequency. Accordingly, the frequency of the third local signal 13 corresponds to the above-mentioned integral multiple of the frequency of the first local signal 11. Assume also that the frequency of the second target interference wave differs from that of the target interference wave (hereinafter, referred to as the “first target interference wave” for convenience sake) in the aforementioned frequency converter 122. The frequency converter 323 supplies the product signal to the baseband filter 333.

The baseband filter 333 is an LPF. The baseband filter 333 performs filtering for suppressing a high-frequency component contained in the product signal sent from the frequency converter 323. In other words, the baseband filter 333 performs filtering for extracting a baseband signal as the low-frequency component of the product signal sent from the frequency converter 323. The baseband filter 333 supplies the baseband signal (hereinafter, also referred to as “the third baseband signal”) to the subtraction processing unit 340.

The subtraction processing unit 340 adjusts the amplitudes of the second and third baseband signals, and then subtracts the adjusted signals from the first baseband signal to obtain a residual signal. The subtraction processing unit 340 supplies the residual signal to the VGA 150. To be more specific, the subtraction processing unit 340 includes an adder 341 and multipliers 342 and 343.

The multiplier 342 multiplies the second baseband signal by a control coefficient (hereinafter, referred to as the “first control coefficient” for convenience sake) supplied from the correlation computation unit 270, thereby obtaining a product signal. The multiplier 342 supplies the product signal to the adder 341.

The multiplier 343 multiplies the third baseband signal by a control coefficient (hereinafter, referred to as the “second control coefficient” for convenience sake) supplied from a correlation computation unit 371 described later, thereby obtaining a product signal. Specifically, it is desirable that the second control coefficient be obtained by inverting the sign of the ratio of the part of the amplitude component of the first baseband signal, which is based on the second target interference wave, to the amplitude of the third baseband signal. The multiplier 343 supplies the product signal to the adder 341.

The adder 341 adds up the first baseband signal from the baseband filter 131, the product signal from the multiplier 342, and the product signal from the multiplier 343, thereby obtaining the aforementioned residual signal. If the first and second control coefficients are appropriate values, the component contained in the first baseband signal and based on the first and second target interference waves is canceled by the residual signal.

The correlation computation unit 371 computes a correlation (hereinafter, referred to as the “second correlation” for convenience sake) between the residual signal from the subtraction processing unit 340 and the third baseband signal from the baseband filter 333. The second correlation is used as an index that indicates the ratio of the component, which is contained in the residual signal and based on the second target interference wave, to the whole residual signal. The correlation computation unit 371 imparts an appropriate gain to the second correlation, and supplies the multiplier 343 with the resultant signal as the aforementioned second control coefficient. The second correlation is controlled to a lower value by the feedback operation of the correlation computation unit 371 and the subtraction processing unit 340.

As described above, the receiver of the third embodiment considers a larger number of interference waves than the receiver of the second embodiment. Therefore, the receiver of the third embodiment can cancel interference waves falling within a broader band.

To compare the receiver of the third embodiment with the receiver of the second embodiment, assume that the upper limit of a band as a reception target is set three times or more the lower limit. In the receiver of the second embodiment, if a frequency converter of a differential structure is used, and the frequency of a target interference wave is set to a value near three times a desired frequency, the interference wave component can be canceled with a certain accuracy. In contrast, in the receiver of the third embodiment, since the frequencies of the first and second target interference waves are set to values near twice and three times a desired frequency, respectively, the interference wave component can be canceled with a higher accuracy. Further, if the reception target band is broader, the receiver may be modified to further increase the number of target interference waves.

### Fourth Embodiment

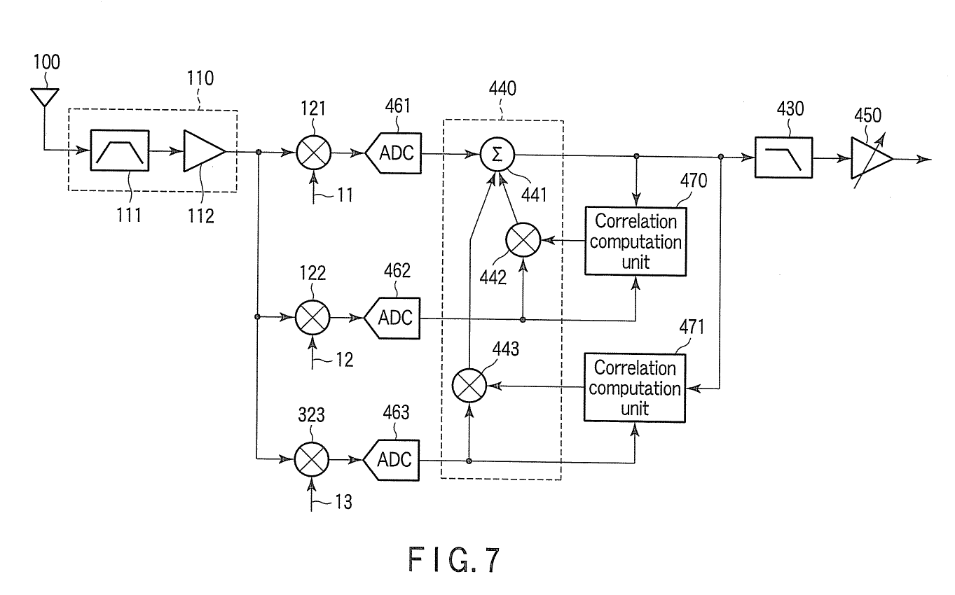

As shown in FIG. 7, a receiver according to a fourth embodiment of the invention is obtained by modifying the receiver shown in FIG. 6 such that different elements are provided after the frequency converters 121, 122 and 323. Specifically, the receiver of the fourth embodiment comprises an antenna 100, a high-frequency amplifying unit 110, frequency converters 121, 122 and 323, ADCs 461, 462 and 463, a subtraction processing unit 440, a baseband filter 430, and a VGA 450. In FIG. 7 and the description corresponding thereto, elements similar to those of FIG. 6 are denoted by corresponding reference numbers, and different elements will be mainly described.

In the receivers of the first to third embodiments, canceling of interference wave components are performed using an analog circuit. However, the analog signal process is not free from factors, such as DC offset, thermal noise, distortion, that adversely affect the canceling accuracy of the interference waves components. Therefore, in the receiver of the fourth embodiment, the interference wave canceling process is performed by a digital circuit.

The ADC 461 is connected to the frequency converter 121, and receives therefrom the aforementioned product signal containing the first baseband signal as a low-frequency component. The ADC 461 performs analog-to-digital conversion on the product signal from the frequency converter 121 to thereby obtain a first digital signal. The ADC 461 supplies the first digital signal to an adder 441 incorporated in the subtraction processing unit 440.

The ADC 462 is connected to the frequency converter 122, and receives therefrom the aforementioned product signal containing the second baseband signal as a low-frequency component. The ADC 462 performs analog-to-digital conversion on the product signal from the frequency converter 122 to thereby obtain a second digital signal. The ADC 462 supplies the second digital signal to a multiplier 442 and a correlation computation unit 470 incorporated in the subtraction processing unit 440.

The ADC 463 is connected to the frequency converter 323, and receives therefrom the aforementioned product signal containing the third baseband signal as a low-frequency component. The ADC 463 performs analog-to-digital conversion on the product signal from the frequency converter 323 to thereby obtain a third digital signal. The ADC 463 supplies the third digital signal to a multiplier 443 and a correlation computation unit 471 incorporated in the subtraction processing unit 440.

The ADCs 461, 462 and 463 are connected to the frequency converters 121, 122 and 323, respectively. Many schemes for realizing an ADC have been proposed so far, and it is known that a delta sigma (ΔΣ) ADC as a continuous time system is appropriate for the above-mentioned purpose. Further, note that the ΔΣ ADC is a so-called oversample ADC, and hence it is necessary to perform down-sampling to an appropriate sample rate using a decimation circuit or decimation filter. Accordingly, assume that the first, second and third digital signals are down-sampled to appropriate sample rates.

The subtraction processing unit 440 adjusts the amplitudes of the second and third digital signals, and then subtracts the adjusted signals from the first digital signal to acquire a digital residual signal. The subtraction processing unit 440 supplies the digital residual signal to the baseband filter 430. As described above, the subtraction processing unit 440 incorporates the adder 441 and multipliers 442 and 443.

The multiplier 442 multiplies the second digital signal by a first digital control coefficient, described later, sent from the correlation computation unit 470, thereby obtaining a product signal. Specifically, it is desirable that the first digital control coefficient be obtained by inverting the sign of the ratio of the part of the amplitude component of the first digital signal, which is based on the first target interference wave, to the amplitude of the second digital signal. The multiplier 442 supplies the product signal to the adder 441.

The multiplier 443 multiplies the third digital signal by a second digital control coefficient, described later, sent from the correlation computation unit 470, thereby obtaining a product signal. Specifically, it is desirable that the second digital control coefficient be obtained by inverting the sign of the ratio of the part of the amplitude component of the first digital signal, which is based on the second target interference wave, to the amplitude of the third digital signal. The multiplier 443 supplies the product signal to the adder 441.

The adder 441 adds up the first digital signal from the ADC 461, the product signal from the multiplier 442, and the product signal from the multiplier 443, thereby obtaining the aforementioned digital residual signal. If the first and second digital control coefficients are appropriate values, the component contained in the first digital signal and based on the first and second target interference waves is canceled by the digital residual signal.

The correlation computation unit 470 computes a first correlation between the digital residual signal from the subtraction processing unit 440 and the second digital signal from the ADC 462. The first correlation is used as an index that indicates the ratio of the component, which is contained in the digital residual signal and based on the first target interference wave, to the whole digital residual signal. The correlation computation unit 470 imparts an appropriate gain to the first correlation, and supplies the multiplier 442 with the resultant signal as the aforementioned first digital control coefficient. The first correlation is controlled to a lower value by the feedback operation of the correlation computation unit 470 and the subtraction processing unit 440.

The correlation computation unit 471 computes a second correlation between the digital residual signal from the subtraction processing unit 440 and the third digital signal from the ADC 463. The second correlation is used as an index that indicates the ratio of the component, which is contained in the digital residual signal and based on the second target interference wave, to the whole digital residual signal. The correlation computation unit 471 imparts an appropriate gain to the second correlation, and supplies the multiplier 443 with the resultant signal as the aforementioned second digital control coefficient. The second correlation is controlled to a lower value by the feedback operation of the correlation computation unit 471 and the subtraction processing unit 440.

The baseband filter 430 is a digital LPF. The baseband filter 430 performs filtering for suppressing a high-frequency component contained in the digital residual signal sent from the subtraction processing unit 440. In other words, the baseband filter 430 performs filtering for extracting a digital baseband signal as the low-frequency component of the digital residual signal. The baseband filter 430 supplies the digital baseband signal to the VGA 450.

The VGA 450 amplifies the digital baseband signal from the baseband filter 430 to obtain an amplified digital signal. The VGA 450 supplies the amplified digital signal to a digital signal processing unit (not shown).

As described above, in the receiver of the fourth embodiment, the digital circuit cancels target interference waves, thereby enhancing the cancel accuracy of the target interference waves. Further, in receiver of the fourth embodiment, the baseband filter is provided after the subtraction processing unit. Therefore, the receiver of the fourth embodiment can be made compact since it is sufficient if only one baseband filter is provided therein.

### Fifth Embodiment

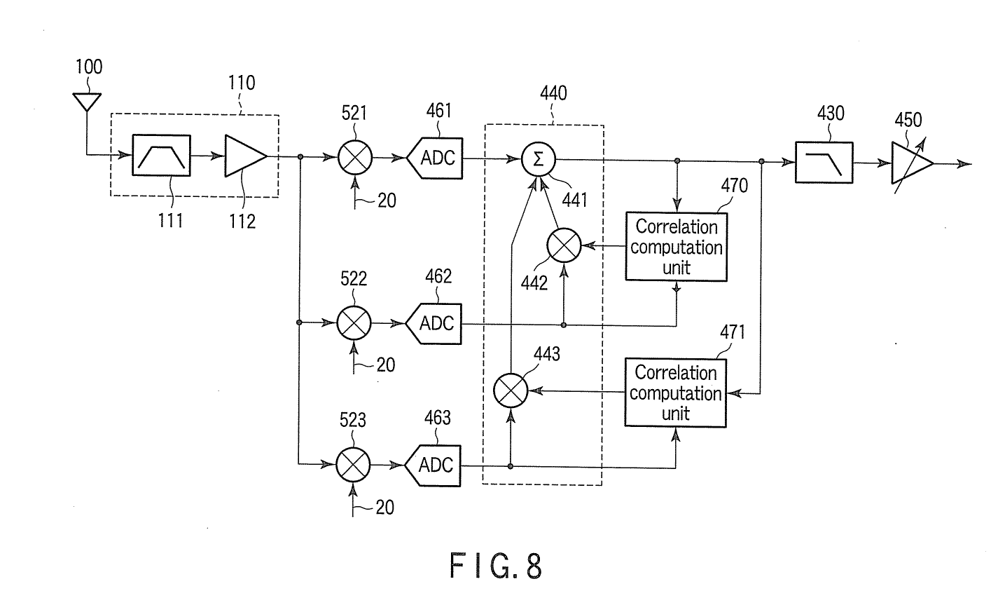

As shown in FIG. 8, a receiver according to a fifth embodiment is obtained by modifying the receiver shown in FIG. 7 such that the frequency converters 121, 122 and 323 are replaced with frequency converters 521, 522 and 523, respectively. In FIG. 8 and the description corresponding thereto, elements similar to those of FIG. 7 are denoted by corresponding reference numbers, and different elements will be mainly described.

The frequency converter 521 is a polyphase frequency converter. The frequency converter 521 performs frequency conversion in which the amplified signal from the LNA 112 is multiplied by a polyphase local signal 20, thereby obtaining a polyphase product signal. Namely, the frequency of the polyphase local signal 20 corresponds to the difference between the desired frequency and the baseband frequency. The frequency converter 521 combines the resultant product signals to thereby cancel the signal components due to the first and second target interference waves, and then supplies them to the ADCs 461.

The polyphase local signal 20 is used to convert a desired frequency into the baseband frequency. Further, when a plurality of target interference waves exist, it is desirable that the number of the signal components (i.e., the number of the phase patterns) of the polyphase local signal 20 be set to a common multiple of the frequency ratios (integer) of the target interference waves to a desired frequency. For instance, if the frequency ratios of the first and second target interference waves to the desired frequency are “2” and “3”, respectively, the number of the phases of the polyphase local signal 20 is desirably set to, for example, “6”. If only one target interference wave exists, the number of the signal component of the polyphase local signal 20 is desirably set to a divisor of the frequency ratio (integer) of the target interference wave to the desired frequency.

The frequency converter 522 is also a polyphase converter. The frequency converter 522 performs frequency conversion in which the amplified signal from LNA 112 is multiplied by the polyphase local signal 20, thereby obtaining a polyphase product signal. The frequency converter 522 combines the signal components of the polyphase product signal to emphasize the signal component due to the first target interference wave and cancel the signal component due to the desired wave, and then supplies the resultant signal to the ADC 462.

The frequency converter 523 is also a polyphase converter. The frequency converter 523 performs frequency conversion in which the amplified signal from LNA 112 is multiplied by the polyphase local signal 20, thereby obtaining a polyphase product signal. The frequency converter 523 combines the signal components of the polyphase product signal to emphasize the signal component due to the second target interference wave and cancel the signal component due to the desired wave, and then supplies the resultant signal to the ADC 463.

The signal processes performed by the frequency converters 521, 522 and 523 will now be described in detail. Assume here as an example that the first target interference wave has a frequency approx. twice the desired frequency, the second target interference wave has a frequency approx. three times the desired frequency, and the polyphase local signal 20 is a six-phase signal. In this case, each of the six-phase product signals obtained by multiplying the amplified signal by the polyphase local signal 20 at least contains a component (hereinafter, the “fundamental wave component”) corresponding to the multiplication result of the desired wave and the fundamental wave of the polyphase local signal 20, a component (hereinafter, the “2nd order harmonic component”) corresponding to the multiplication result of the first target interference wave and the 2nd order harmonic of the polyphase local signal 20, and a component (hereinafter, the “3rd order harmonic component”) corresponding to the multiplication result of the second target interference wave and the 3rd order harmonic of the polyphase local signal 20. In each of the six-phase product signals, the fundamental wave component, the 2nd order harmonic component and the 3rd order harmonic component have various phases. Specifically, the fundamental wave component has 6 (=6/1) phase patterns, the 2nd order harmonic component has 3 (=6/2) phase patterns, and the 3rd order harmonic component has 2 (=6/3) phase patterns.

The frequency converter 521 groups the six-phase product signals into three groups each formed of two signals in which their 2nd order harmonic components are in phase with each other, and suppresses the common mode components of each group (i.e., cancels the 2nd order harmonic components). To suppress the common mode components, a so-called common mode feedback circuit (CMFB circuit) can be used. After that, the frequency converter 521 groups the six-phase product signals with their 2nd order harmonic components canceled into two groups each formed of three signals in which their 3rd order harmonic components are in phase with each other, and suppresses the common mode components of each group (i.e., cancels the 3rd order harmonic components). Alternatively, the 2nd order harmonic component canceling process may be performed after the 3rd order harmonic component canceling process. Further, in the 2nd order harmonic component canceling process, the 4th order, 6th order, 8th order, . . . , (i.e., any even order) harmonic components are also canceled. Similarly, in the 3rd order harmonic component canceling process, the 6th order, 9th order, 12th order, . . . , (i.e., any multiple order of three) harmonic components are also canceled.

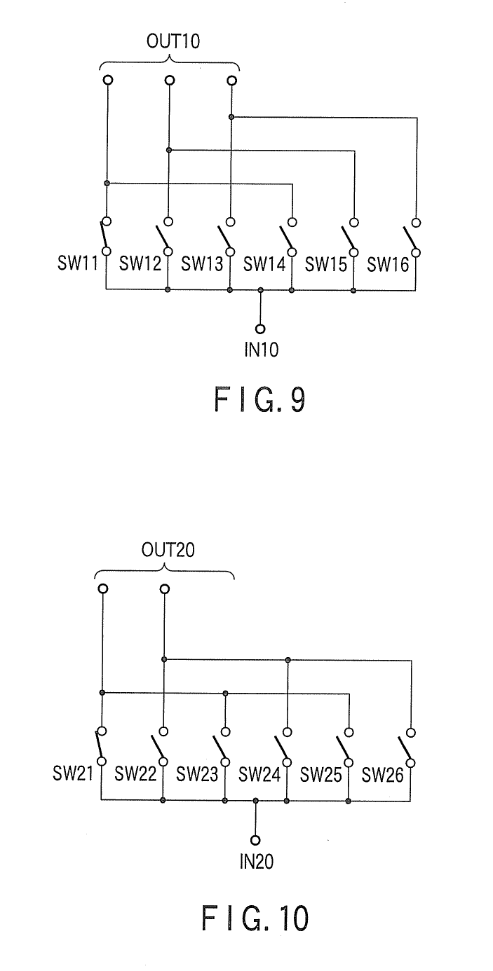

The frequency converter 522 is formed of, for example, a six-phase mixer formed of six switches as shown in FIG. 9. The frequency converter 522 groups the six-phase product signals into three groups each formed of two signals in which their 2nd order harmonic components are in phase with each other, and superimposes the signals in each group to emphasize the 2nd order harmonic components. Further, the superimposition of the signals in each group cancels the fundamental frequency component. Yet further, in the emphasis process of the 2nd order harmonic components, the 4th order, 6th order, 8th order, . . . , (i.e., any even order) harmonic components are also emphasized.

The frequency converter 523 is formed of, for example, a six-phase mixer formed of six switches as shown in FIG. 10. The frequency converter 523 groups the six-phase product signals into three groups each formed of three signals in which their 3rd order harmonic components are in phase with each other, and superimposes the signals in each group to emphasize the 3rd order harmonic components. Further, the superimposition of the signals in each group cancels the fundamental frequency component. Yet further, in the emphasis process of the 3rd order harmonic components, the 6th order, 9th order, 12th order, . . . , (i.e., any multiple order of three) harmonic components are also emphasized.

Although the frequency converter 521 cancels the 2nd and 3rd order harmonic components (i.e., the signal components due to the first and second target interference waves), the 2nd order (and any even order) harmonic component and the 3rd order (and any multiple order of three) harmonic component may remain because of, for example, an element-level error of a silicon integrated circuit, such as an error in the CMFB circuit. In light of this, the frequency converters 522 and 523 once emphasize the 2nd order (and any even order) harmonic component and the 3rd order (and any multiple order of three) harmonic component, and the subtraction processing unit 440 provided after the frequency converters cancels the emphasized components, whereby higher accurate canceling of target interference waves can be realized.

As described above, in the receiver of the fifth embodiment, the polyphase frequency converters are used to cancel target interference waves, and the subtraction processing unit is also used to cancel them. As a result, interference waves can be canceled with high accuracy over a broad band.

Although in the fifth embodiment, the frequency converters 121, 122 and 323 are replaced with the frequency converters 521, 522 and 523, the converters shown in FIG. 1, 2 or 6 may be replaced with the corresponding frequency converters.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A receiver comprising:
a high-frequency filter which extracts, from a radio signal, a high-frequency signal;
a first frequency converter which performs frequency conversion on the high-frequency signal using a first local signal, to obtain a first baseband signal;
a second frequency converter which performs frequency conversion on the high-frequency signal using a second local signal, to obtain a second baseband signal, the second local signal having a frequency equal to an integral multiple of a frequency of the first local signal; and
a subtraction processing unit configured to multiply the second baseband signal by a control coefficient for amplitude adjustment to obtain a product signal, and subtract the product signal from the first baseband signal to obtain a residual signal.

2. The receiver according to claim 1, further comprising a computation unit configured to compute the control coefficient based on the second baseband signal and the residual signal, and feed back, to the subtraction processing unit.

3. The receiver according to claim 2, wherein the computation unit includes:
a first direct current elimination filter which eliminates a direct current component of the residual signal;
a second direct current elimination filter which eliminates a direct current component of the second baseband signal;
a multiplier which multiplies an output signal of the first direct current elimination filter by an output signal of the second direct current elimination filter; and
a low-pass filter which extracts, as the control coefficient, a low-frequency component of a signal output from the multiplier.

4. The receiver according to claim 1, wherein:
the second frequency converter is connected to an oscillator which outputs the second local signal; and
the first frequency converter is connected to a frequency dividing circuit which divides the frequency of the second local signal to obtain the first local signal.

5. The receiver according to claim 1, wherein:
the second frequency converter is connected to a first frequency dividing circuit which divides a frequency of an oscillation signal output from an oscillator; and
the first frequency converter is connected to a second frequency dividing circuit which divides the frequency of the second local signal to obtain the first local signal.

6. The receiver according to claim 1, further comprising:
a first analog-to-digital converter connected after the first frequency converter and arranged to perform analog-to-digital conversion on the first baseband signal; and
a second analog-to-digital converter connected after the second frequency converter and arranged to perform analog-to-digital conversion on the second baseband signal,
and wherein the subtraction processing unit is a digital circuit.

7. The receiver according to claim 1, wherein,
the first frequency converter is an orthogonal demodulator, the second frequency converter is an orthogonal demodulator, and the control coefficient is a complex number or a real number matrix of two rows and two columns, and the subtraction processing unit performs complex number operation or matrix operation.

8. A receiver comprising:
a high-frequency filter which extracts, from a radio signal, a high-frequency signal;
a first frequency converter which performs frequency conversion on the high-frequency signal using a first local signal, to obtain a first baseband signal;
a second frequency converter which performs frequency conversion on the high-frequency signal using a second local signal, to obtain a second baseband signal, the second local signal having a frequency equal to an integral multiple of a frequency of the first local signal;
a third frequency converter which performs frequency conversion on the high-frequency signal using a third local signal, to obtain a third baseband signal, the third local signal having a frequency that is equal to an integral multiple of the frequency of the first local signal and differs from the frequency of the second local signal; and
a subtraction processing unit configured to multiply the second baseband signal by a first control coefficient for amplitude adjustment to obtain a first product signal, multiply the third baseband signal by a second control coefficient for amplitude adjustment to obtain a second product signal, subtract the first product signal and the second product signal from the first baseband signal to obtain a residual signal.

9. A receiver comprising:
a high-frequency filter which extracts, from a radio signal, a high-frequency signal;
a first frequency converter which multiplies the high-frequency signal by a polyphase local signal to obtain a polyphase signal, combines signal components of the polyphase signal into a first combination signal, and cancels a signal component of the first combination signal due to a harmonic component of the polyphase local signal, to obtain a first baseband signal;
a second frequency converter which multiplies the high-frequency signal by the polyphase local signal to obtain the polyphase signal, combines signal components of the polyphase signal into a second combination signal, and cancels a signal component of the second combination signal due to a fundamental wave component of the polyphase local signal, to obtain a second baseband signal; and
a subtraction processing unit configured to multiply the second baseband signal by a control coefficient for amplitude adjustment to obtain a product signal, and subtract the product signal from the first baseband signal to obtain a residual signal.
